(19) United States
(12) Patent Application Publication
(10) Pub. No.: US 2017/0074140 A1
(43) Pub. Date: Mar. 16, 2017

(54) GAS/LIQUID MIXING DEVICE FOR EXHAUST AFTERTREATMENT

(71) Applicant: GM GLOBAL TECHNOLOGY OPERATIONS LLC, Detroit, MI (US)

(72) Inventor: Gary P. Byford, Waterford, MI (US)

(21) Appl. No.: 14/853,052

(22) Filed: Sep. 14, 2015

(51) Int. Cl. F01N 3/20; F01N 3/10; F01N 13/08; B01F 5/06; B01D 53/94

(52) U.S. Cl. CPC F01N 3/2066; B01F 5/0602; B01D 53/944; B01D 53/9418; F01N 13/08; F01N 3/106; B01D 2251/2062; B01D 2251/208; F01N 2610/02; F01N 2610/03

(57) ABSTRACT

A mixing device for an exhaust gas conduit comprises a first, inner sleeve having an upstream end, a downstream end and an inner passage extending therethrough having a diameter “D”. A deflector fin is formed in the first, inner sleeve and extends into the inner passage. A second, outer air-gap shell has an upstream end, a downstream end and a central portion having a diameter “D1” that is larger than the diameter D of the first, inner sleeve. The inner sleeve is disposed in the second, outer air-gap shell and the upstream and downstream ends are sealingly fixed to the first, inner sleeve to define an air-gap about the portion of the first, inner sleeve in which the deflector fin is formed.

### FIELD OF THE INVENTION

Exemplary embodiments of the invention are related to exhaust gas treatment systems and, more particularly, to an exhaust gas treatment system for internal combustion engines and vehicles incorporating the same.

### BACKGROUND

Manufacturers of internal combustion engines must meet customer requirements while addressing various regulations for reduced emissions and improved fuel economy. Several types of exhaust treatment systems are used in vehicle applications of internal combustion engines. These systems employ various exhaust treatment devices. One such exhaust treatment system employs a urea Selective Catalyst Reduction (“SCR”) catalyst and a NOx reductant (e.g. urea) that is injected upstream of the SCR catalyst using a fluid injector. The NOx reductant is converted to ammonia in the exhaust gas stream that is then used to reduce the NOx to N2. The use of urea as a reductant necessitates a urea delivery system and an on-board monitoring system for this secondary fluid.

An exhaust treatment technology used to control high levels of particulate matter in the exhaust gas is a Diesel Particulate Filter (“DPF”) device. There are several known filter structures used in DPF devices that have displayed effectiveness in removing particulate matter from exhaust gas such as ceramic honeycomb wall-flow filters, wound or packed fiber filters, open cell foams, sintered metal fibers, etc. Ceramic wall flow filters have experienced significant acceptance in automotive applications. The filter is a physical structure for removing particulates from exhaust gas and, as a result, the accumulation of filtered particulate matter will have the effect of increasing the exhaust system backpressure that is experienced by the engine. To address backpressure increases caused by the accumulation of exhaust gas particulates, the DPF device is periodically cleaned or regenerated. Regeneration of a DPF device in vehicle applications is typically automatic and is controlled by an engine or other controller based on signals generated by engine and exhaust system sensors. The regeneration event involves increasing the temperature of the filter to levels that will combust the accumulated particulate matter.

One method of generating the temperatures required in the exhaust system for regeneration of the DPF device is to deliver unburned hydrocarbon (“HC”) to an oxidation catalyst device that is disposed upstream of the DPF device. The HC may be delivered by injecting fuel directly into the exhaust gas system typically using an exhaust fluid injector. The HC is oxidized in the oxidation catalyst device resulting in an exothermic reaction that raises the temperature of the exhaust gas. The heated exhaust gas travels downstream to the DPF device and burns the particulate accumulation in the filter. While systems that employ SCR catalysts, DPF devices and oxidation catalysts have been used for reduced emissions in exhaust gas flow streams, the packaging of the various devices has been problematic, particularly in relatively small vehicles having short wheelbases, due to the reduced space available to package the combinations of devices and the associated injection systems required for the introduction of the various exhaust treatment fluids described. Various mixers have been proposed but may suffer from detractions.

### SUMMARY OF THE INVENTION

In an exemplary embodiment a mixing device for an exhaust gas conduit comprises a first, inner sleeve having an upstream end, a downstream end and an inner passage extending therethrough having a diameter “D”; a deflector fin formed in the first, inner sleeve and extending into the inner passage; and a second, outer air-gap shell having an upstream end, a downstream end and a central portion having a diameter “D1” that is larger than the diameter D of the first, inner sleeve. The inner sleeve is disposed in the second, outer air-gap shell and the upstream and downstream ends are sealingly fixed to the first, inner sleeve to thereby define an air-gap about the portion of the first, inner sleeve in which the deflector fin is formed.

In another exemplary embodiment an exhaust gas system for an internal combustion engine comprises an exhaust gas conduit configured to transport exhaust gas from the internal combustion, an exhaust treatment device disposed in the exhaust gas conduit and a mixing device disposed in the exhaust gas conduit, upstream of said exhaust treatment device. The mixing device comprises a first, inner sleeve having an upstream end, a downstream end and an inner passage extending therethrough having a diameter “D”, a deflector fin formed in the first, inner sleeve and extending into the inner passage, and a second, outer air-gap shell having an upstream end, a downstream end and a central portion having a diameter “D1” that is larger than the diameter D of the first, inner sleeve. The inner sleeve is disposed in the second, outer air-gap shell and the upstream and downstream ends are sealingly fixed to the first, inner sleeve to thereby define an air-gap about the portion of the first, inner sleeve in which the deflector fin is formed.

The above features and advantages, and other features and advantages of the invention are readily apparent from the following detailed description for carrying out the invention when taken in connection with the accompanying drawings.

### BRIEF DESCRIPTION OF THE DRAWINGS

Other features, advantages and details appear, by way of example only, in the following description of embodiments, the description referring to the drawings in which:

FIG. 1 is a schematic view of an internal combustion engine and exhaust system embodying features of the invention;

FIG. 2 is partial, phantom view of a diesel particulate filter device from FIG. 1, taken at Circle 2 in FIG. 1, embodying features of the invention;

FIG. 3 is partial, sectional view, with parts omitted, of the diesel particulate filter device of FIG. 2;

FIG. 4 is a disassembled view of an exhaust inner sleeve mixer from FIG. 1, embodying features of the invention;

FIG. 5A illustrates an embodiment of a deflector fin of the exhaust inner sleeve mixer of FIG. 4;

FIG. 5B illustrates another embodiment of the deflector fin of the exhaust inner sleeve mixer of FIG. 4;

FIG. 5C illustrates another embodiment of the deflector fin of the exhaust inner sleeve mixer of FIG. 4; and

FIG. 6 is a partial, phantom view of the exhaust system of FIG. 1, taken at Circle 6 in FIG. 1, embodying features of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein the term vehicle is not limited to just an automobile, truck van or sport utility vehicle, but includes any self-propelled or towed conveyance suitable for transporting a burden.

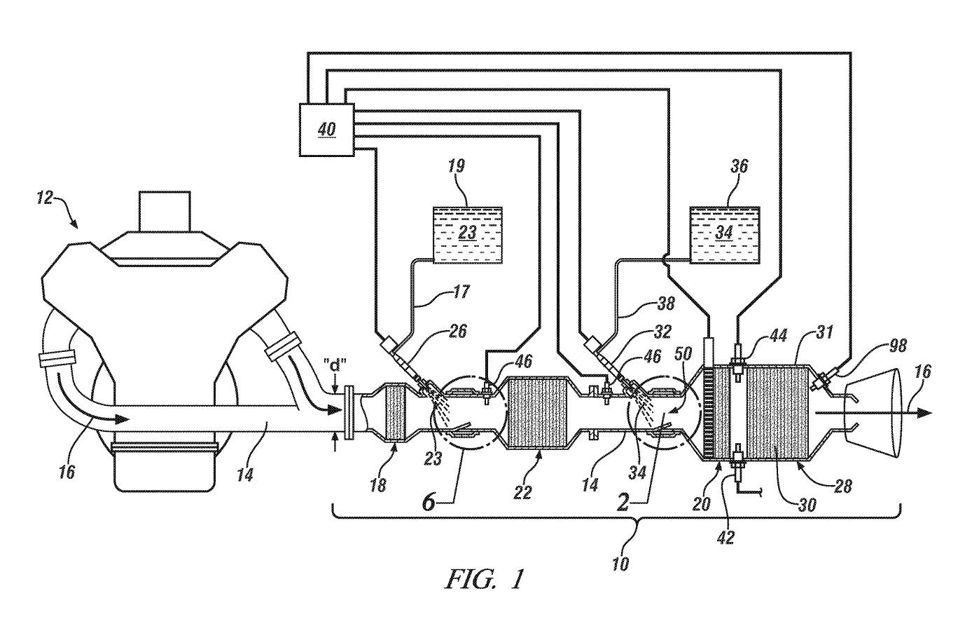

Referring now to FIG. 1, in an exemplary embodiment an exhaust treatment system 10 for the reduction of regulated exhaust gas constituents from an internal combustion (“IC”) engine 12 is shown. Such systems may include, but are not limited to gasoline, Diesel and homogeneous charge compression ignition engine systems. The exhaust gas treatment system includes an exhaust gas conduit 14, which may comprise several segments, that functions to transport exhaust gas 16 from the IC engine 12 to various exhaust treatment devices. The exhaust treatment devices may include an oxidation catalyst (“OC”) device 18. The OC device has an oxidation catalyst compound containing platinum group metals such as Platinum (“Pt”), Palladium (“Pd”), rhodium (“Rh”) or other suitable oxidizing catalysts, or combinations thereof applied thereto. The OC device is useful in treating unburned gaseous and non-volatile hydrocarbon (“HC”) and carbon monoxide (“CO”), which are oxidized to form carbon dioxide and water.

A Selective Catalyst Reduction (“SCR”) device 22 may be disposed downstream of the OC device 18. In a manner similar to the OC device, the SCR device 22 has a selective catalyst reduction catalyst compound containing a zeolite and one or more base metal components such as iron (“Fe”), cobalt (“Co”), copper (“Cu”) or vanadium (“V”), or combinations thereof applied thereto. The catalyst compounds operate efficiently to convert NOₓ constituents in the exhaust gas 16, in the presence of an injected fluid such as an ammonia (“NH₃”) reductant. The NH3 reductant 23, supplied from a reductant supply tank 19 through conduit 17, may be injected into the exhaust gas conduit 14 at a location upstream of the SCR device 22 using an injector 26.

In one exemplary embodiment of an exhaust treatment system 10, an exhaust gas filter assembly, in this case a diesel particulate filter (“DPF”) device 28 is located within the exhaust gas treatment system, downstream of the SCR device 22 and operates to filter the exhaust gas 16 of carbon and other particulate matter. The DPF device 28 may be constructed using a ceramic wall-flow monolith filter 30 having an inlet and an outlet in fluid communication with exhaust gas conduit 14. Exhaust gas 16 entering the filter 30 is forced to migrate through adjacent longitudinally extending walls (not shown) and it is through this wall-flow mechanism that the exhaust gas 16 is filtered of carbon and other particulate matter. The filtered particulates are deposited in the filter 30 and, over time, will have the effect of increasing the exhaust gas backpressure experienced by the IC engine 12.

In an exemplary embodiment, the increase in exhaust backpressure caused by the accumulation of particulate matter requires that the DPF device 28 be periodically cleaned, or regenerated. Regeneration involves the oxidation or burning of the accumulated carbon and other particulate matter in what is typically a high temperature (>600° C.) environment. For regeneration purposes a second OC device 20 may be located upstream of the filter 30, proximate to its upstream end. In the embodiment illustrated, the second OC device 20 is disposed in the canister 31 of the DPF device 28. It is, however, contemplated that, depending on packaging and other system constraints, the second OC device 20 may also be disposed within a separate canister (not shown) that is located upstream of the DPF device 28 (ex. OC device 18). Disposed upstream of the OC device 20, in fluid communication with the exhaust gas 16 in the exhaust gas conduit 14, is an HC or fuel injector 32. The fuel injector 32 is in fluid communication with liquid hydrocarbon 34 in fuel supply tank 36 through fuel conduit 38. The fuel injector 32 introduces fluid such as unburned HC 34 into the exhaust gas stream 16 for delivery to the OC device 20.

A controller 40, such as a vehicle or engine controller, is operably connected to, and monitors, the exhaust gas treatment system 10 through signal communication with a number of sensors. As used herein the term controller may include an application specific integrated circuit (ASIC), an electronic circuit, a processor (shared, dedicated or group) and memory that executes one or more software or firmware programs, a combinational logic circuit, and/or other suitable components that provide the described functionality.

NOx sensors 46 located near the SCR device 22 generate signals indicative of the NOx levels in the exhaust gas 16. Upon a determination that the NOx levels have reached a predetermined level the controller 40 may activate the injector 26 to deliver reductant 23 into the exhaust gas conduit 14 for mixing with the exhaust gas 16. The ammonia/exhaust gas mixture enters the SCR device 22 where the ammonia reduces the NOx to N2.

Oxygen (O2) sensor 42 and backpressure sensor 44, located near the second OC device 20 and the DPF device 28, generate signals indicative of the function of the OC device and the carbon and particulate loading in the ceramic wall flow monolith filter 30. Upon a determination that the backpressure in the DPF device has reached a predetermined level indicative of the need to regenerate the DPF device 28, the controller 40 activates the HC injector 32 to deliver HC 34 into the exhaust gas conduit 14 for mixing with the exhaust gas 16. The fuel/exhaust gas mixture enters the OC device 20 inducing oxidation of the HC in the exhaust gas 16 and raising the exhaust gas temperature to a level (e.g. >600° C.) suitable for regeneration of the carbon and particulate matter in the filter 30. The controller 40 may monitor the temperature of the exothermic oxidation reaction in the second OC device 20 and the ceramic wall-flow monolith filter 30 through temperature sensor 48 and adjust the HC delivery rate of injector 32 to maintain a predetermined temperature.

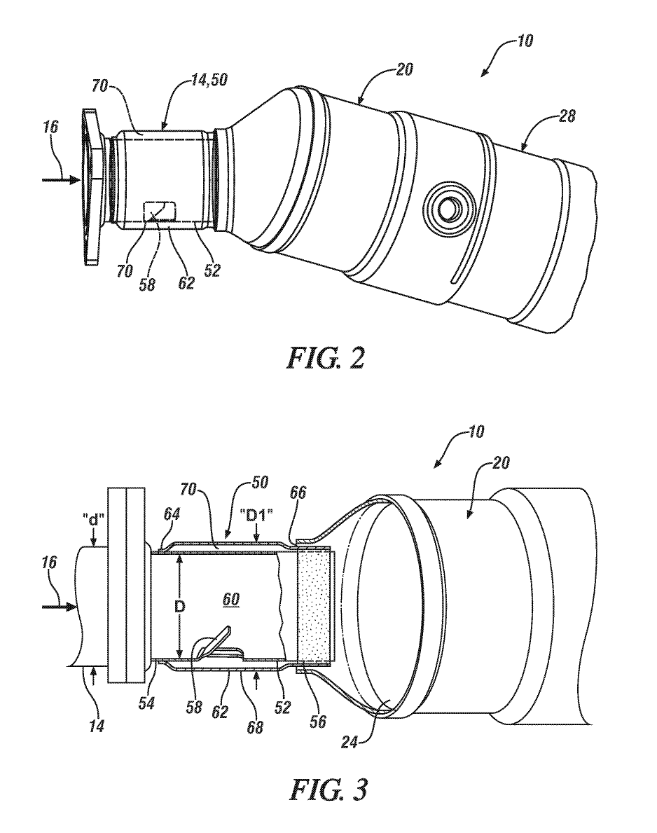

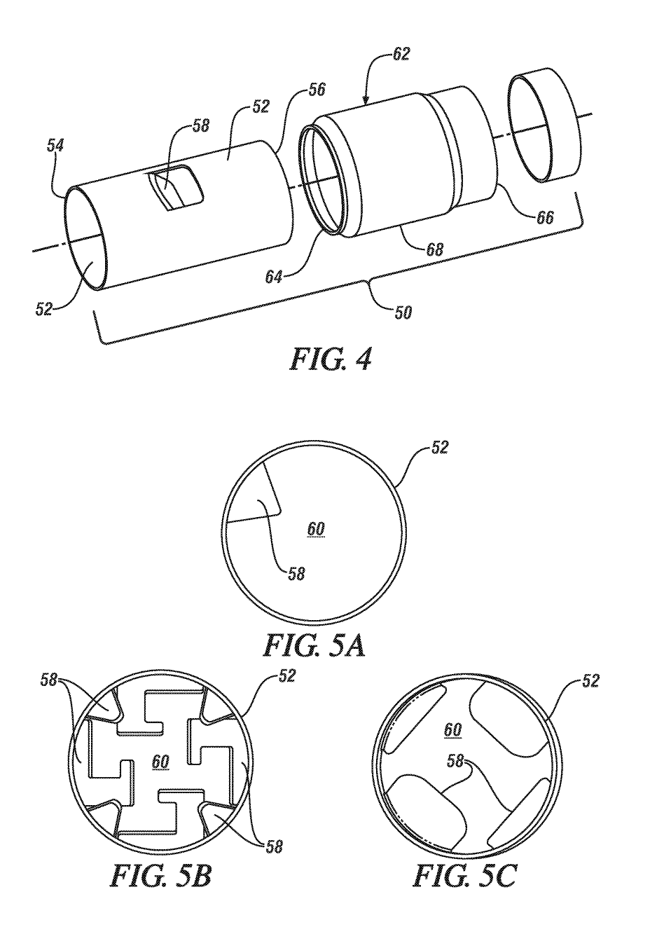

Referring now to FIGS. 2, 3 and 4, with continuing reference to FIG. 1, a portion of the exhaust treatment system 10 is illustrated upstream of the DPF device 28. As noted, upon a determination that filter 30 of the DPF device 28 requires regeneration, the controller 40 will activate the HC injector 32 that is positioned upstream of the OC device 20. Regardless of the space (i.e. length, geometry, etc.) provided in the conduit 14 between the HC injector 32 and the second OC device 20, it is desirable that the injected liquid hydrocarbon 34 fully atomize and/or vaporize in the exhaust gas 16 as well as fully diffuse and become mixed with the exhaust gas in order to be well distributed throughout the OC device 18 to ensure efficient oxidation as it passes over the oxidation catalyst. For this reason, in an embodiment, an exhaust inner sleeve mixer 50 is disposed downstream of the HC injector 32 and is configured to induce turbulence into the exhaust gas stream to disrupt stratification in the stream to assure that the exhaust gas 16 becomes a homogeneous mixture of its various constituents and to improve the distribution of the exhaust gas across the face of the OC device catalyst substrate 24, for instance. In an embodiment, the exhaust inner sleeve mixer comprises a first, inner sleeve 52 having a first, upstream end 54, a second, downstream end 56 and a diameter “D” that, in an embodiment is substantially the same as the diameter “d” of the exhaust gas conduit 14. As a result, exhaust gas 16 passing through the first inner sleeve 52 is not subject to a noticeable change in diameter that would negatively affect the flow characteristics thereof. A deflector fin 58 is formed in the first, inner sleeve 52 and extends into the axially extending inner passage 60 that is defined by the first, inner sleeve 52. The deflector fin 58 may include any of a number of configurations, FIG. 5, depending on the flow characteristics that are desired in the exhaust gas 16 downstream thereof. Additionally, more than one deflector fin 58 may be formed in the inner sleeve 52 depending again, on the flow characteristics that are desired in the exhaust gas 16 downstream thereof. In the embodiment illustrated, the deflector fin 58 is punched or cut into (i.e. formed from) the first, inner sleeve 58 and, as such, is integral with the inner sleeve. The result is a durable mixing apparatus that does not suffer the risk of dislodging over time, nor does it involve the manufacturing complexity of installation into the exhaust conduit 14 that traditional exhaust mixers typically require.

The exhaust inner sleeve mixer 50 further comprises a second, outer air-gap shell 62 having a first, upstream end 64, a second, downstream end 66 and a central portion 68 having a diameter “D1” that, in an embodiment is larger than the diameter D of the first, inner sleeve 52. In an embodiment, the first, inner sleeve 52 is disposed in the second, outer air-gap shell 62 and the first and second ends 64, 66 of the outer air-gap shell are sealingly welded to the first, inner sleeve 52 to thereby define a leak-free air-gap 70 about that portion of the first, inner sleeve in which the deflector or deflector fins 58 are formed. The application of the second, outer air-gap shell 62 provides several benefits. First, the outer air-gap shell allows for the integration of the deflector fin or fins 58 into the first, inner sleeve resulting in an exhaust gas mixer in that has no additional components assembled into the exhaust gas conduit 14 that may become dislodged with wear-and-tear caused by age or other influences. Additionally, the leak-free, air-gap 70 defines a thermally insulating layer between the hot exhaust gas 16 and the exterior of the exhaust treatment system that is useful to retain heat in the exhaust gas, for the purposes of regenerating the DPF device 28, as well as reducing the thermal load of the exhaust treatment system 10 on vehicle components that may be located in close proximity thereto. For additional thermal isolation, it is contemplated that a layer of heat resistant thermal insulation may be disposed in the air-gap 70.

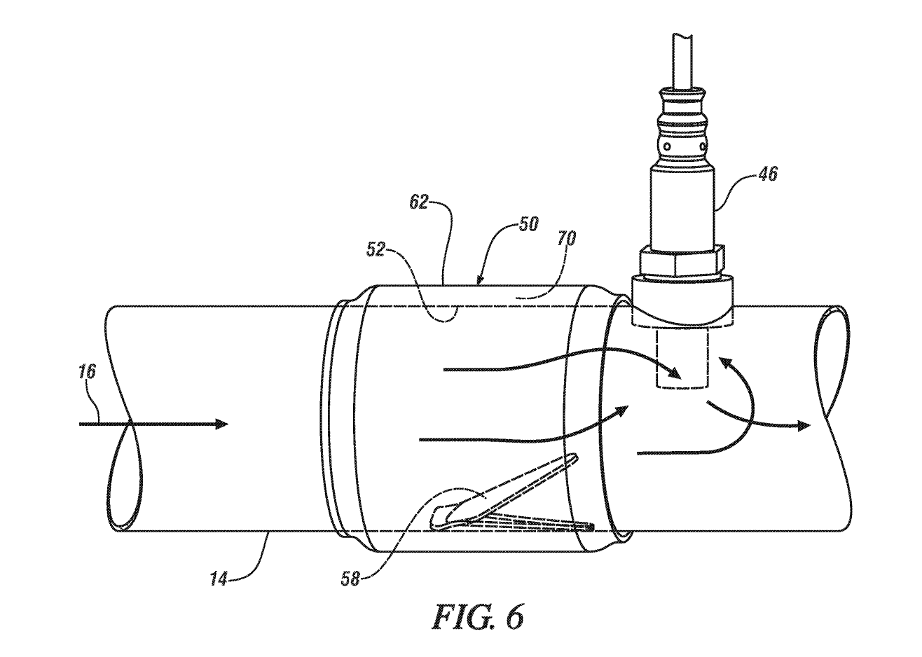

Referring now to FIG. 6, in an embodiment, it may be useful to place an exhaust sleeve inner mixer 50 in a location such as upstream of the SCR device 22. In this placement of the mixer, is desirable to assure adequate turbulence in the exhaust gas 16 such that the NOx Sensor 46 is exposed to an accurate sampling of the exhaust gas as it transmits information to the controller 40. Without precise information regarding the make-up of the exhaust gas 16, the controller may command the NH3 injector 26 to inject too much or too little reductant upstream of the SCR device 22 which can result in improper treatment of NOx constituent in the exhaust gas 16.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A mixing device for an exhaust gas conduit comprising:
a first, inner sleeve having an upstream end, a downstream end and an inner passage extending therethrough having a diameter “D”;
a deflector fin formed in the first, inner sleeve and extending into the inner passage;
a second, outer air-gap shell having an upstream end, a downstream end and a central portion having a diameter “D1” that is larger than the diameter D of the first, inner sleeve, wherein the inner sleeve is disposed in the second, outer air-gap shell and the upstream and downstream ends are sealingly fixed to the first, inner sleeve to thereby define an air-gap about the portion of the first, inner sleeve in which the deflector fin is formed.

2. The mixing device of claim 1, further comprising a layer of heat resistant thermal insulation disposed in the air-gap.

3. The mixing device of claim 1, further comprising more than one deflector fin formed in the inner sleeve.

4. The mixing device of claim 1, wherein the deflector fin is punched or cut from the inner sleeve.

5. The mixing device of claim 1, wherein the air-gap is leak-free.

6. An exhaust gas system for an internal combustion engine comprising:
an exhaust gas conduit configured to transport exhaust gas from the internal combustion an exhaust treatment device disposed in the exhaust gas conduit; and
a mixing device disposed in the exhaust gas conduit, upstream of said exhaust treatment device, comprising:
a first, inner sleeve having an upstream end, a downstream end and an inner passage extending therethrough having a diameter “D”;
a deflector fin formed in the first, inner sleeve and extending into the inner passage;
a second, outer air-gap shell having an upstream end, a downstream end and a central portion having a diameter “D1” that is larger than the diameter D of the first, inner sleeve, wherein the inner sleeve is disposed in the second, outer air-gap shell and the upstream and downstream ends are sealingly fixed to the first, inner sleeve to thereby define an air-gap about the portion of the first, inner sleeve in which the deflector fin is formed.

7. The exhaust gas treatment system of claim 6, wherein the exhaust treatment device comprises one of an oxidation catalyst device and a selective catalyst reduction device.

8. The exhaust gas treatment system of claim 7, further comprising a fluid injector disposed upstream of the exhaust treatment device for injection of a fluid into the exhaust gas.

9. The exhaust gas treatment system of claim 8, wherein the fluid is one of an ammonia reductant or a hydrocarbon.

10. The exhaust gas treatment system of claim 6, wherein the exhaust treatment device comprises a diesel particulate filter device.

11. The exhaust gas treatment system of claim 6, further comprising a layer of heat resistant thermal insulation disposed in the air-gap.

12. The exhaust gas treatment system of claim 6, further comprising more than one deflector fin formed in the inner sleeve.

13. The exhaust gas treatment system of claim 6, wherein the deflector fin is punched or cut from the inner sleeve.

14. The exhaust gas treatment system of claim 6, wherein the air-gap is leak-free.
